(19) United States
(12) Patent Application Publication
(10) Pub. No.: US 2026/0227040 A1
(43) Pub. Date: Aug. 6, 2026

(54) A MODULAR LIGHTING FIXTURE STRUCTURE

(71) Applicant: Safak EMRENCE, Kadiköy, Istanbul (TR)

(72) Inventor: Safak EMRENCE, Kadiköy, Istanbul (TR)

(21) Appl. No.: 19/152,067

(22) PCT Filed: Mar. 22, 2024
(86) PCT No.: PCT/TR2024/050287

§ 371 Date: Jul. 30, 2025

(30) Foreign Application Priority Data
Apr. 10, 2023 (TR) 2023/003926

(51) Int. Cl. F21S 2/00; F21S 6/00; F21V 15/015; F21V 17/10; F21V 17/12; F21V 23/04; F21V 23/06; F21Y 115/10; H05B 45/10; H05B 47/19

(52) U.S. Cl. CPC F21S 2/005; F21S 6/002; F21S 6/005; F21V 15/015; F21V 17/105; F21V 17/12; F21V 23/0435; F21V 23/06; H05B 45/10; H05B 47/19; F21Y 2115/10

(57) ABSTRACT

The invention is particularly related to a modular lighting fixture structure (A) that meets the lighting needs through a single product, such as table lamp, lampshade, bedside lamp and standing lighting fixture, and which can be transformed into the fixture to be used at that moment by the user, depending on the intended use, without requiring any assembly or fixing.

### TECHNICAL FIELD

The invention relates to a modular lighting fixture structure that can be used for multi-purposes and does not require assembly.

The invention is particularly related to a modular lighting fixture structure that meets the lighting needs through a single product, such as table lamp, lampshade, bedside lamp and standing lighting fixture, and which can be transformed into the fixture to be used at that moment by the user, depending on the intended use, without requiring any assembly or fixing.

### BACKGROUND OF THE INVENTION

Lighting fixtures are one of the most frequently used systems in indoor and outdoor lighting. Fixtures that can have many lamps on them can be used in many different ways for different purposes, as table lamps, lampshades, bedside lighting or floor lamps.

Although it is possible to make certain adjustments to direct the light in state-of-the-art lighting fixtures (such as table lamps), they cannot serve other purposes because they are customized according to their intended use.

In the current technique, modular fixtures require a rail or an equivalent component that carries electrical energy and serves to fix the luminaire. To use this fixture, this component must be fixed to the ceiling or wall.

There is no Plug and Play solution. Since it is used fixed to the wall or ceiling and due to its structure, it cannot meet the purposes of use such as table lamp, lampshade, bedside lighting and standing lighting fixture. They are limited to use only as display or performance lighting.

Although some state-of-the-art luminaires are available that allow luminaires to be attached to a linear carrier extending from a base on the ground, in such approaches only the number of modules can be adjusted. Since the carrier pipe remains fixed, it cannot be used for various purposes. It can only be used as a pedestal fixture.

Technical knowledge and/or tool use or professional support is required for the necessary adjustments, increases and decreases to make the mentioned fixtures more useful, even for a specific purpose. It is not easily possible for every user to make these customizations.

There is no fixture structure in the current technique that allows a single luminaire to be used as a table lamp, a lampshade, a bedside lamp or a standing fixture.

In the literature, in the patent application numbered TR 201707580, it is stated that “This invention; It is about the modular lighting system used in the lighting industry, which can be attached to each other in infinite lengths and controlled at the desired angle, and can be used in surface-mounted and suspended model versions.” statements are included.

In the said application, an infinitely long lighting mechanism that can be positioned at any desired angle to the right and left is disclosed.

Again, in the patent document numbered TR 2019 05945 in the literature, it is stated that “Hexagonal LED modules hold on to each other and energy transfer is achieved thanks to the magnets and power transfer surfaces on each edge. When any LED module is connected to the power adapter, all modules are energized. Then, thanks to the capacitive touch sensor in each module, the LEDs in the touched module turn on, and when touched again, they turn off.” statements are included.

The mentioned application describes a lighting fixture that can be connected to each other via magnets on its side edges and turns on when touched with a capacitive touch sensor.

Again, in the Chinese utility model application numbered CN203671521U in the literature, it is stated that “The utility model discloses splicing lamp caps. Each splicing lamp cap comprises a front-end connector and a rear-end connector. The front-end connectors are provided with front-end installation cavities installed cooperatively with lamp tubes. The rear-end connectors are provided with rear-end installation cavities installed cooperatively with the lamp tubes. The front-end connectors are provided with insertion cavities, the rear-end connectors are provided with insertion heads installed cooperatively with the insertion cavities, and the front-end connectors and the rear-end connectors are installed together by installing the insertion heads in the insertion cavities cooperatively. The utility model further provides the row type connection lamp tubes. The row type connection lamp tubes comprise a plurality of the splicing lamp caps. The lamp tubes are installed between every two adjacent lamp caps, one ends of the lamp tubes are installed in the front-end installation cavities, and the other ends of the lamp tubes are installed in the rear-end installation cavities. The splicing lamp caps and the row type connection lamp tubes with the same are simple in structure, the non-illumination dark space among the lamp tubes is reduced to the maximum degree, and continuous and uninterrupted row type illumination effect can be achieved conveniently.” statements are included.

In the said application, a fixture for combining lamp covers and in-line connection lamp tubes in the same way is disclosed.

Also in the literature, in the US patent application numbered U.S. Pat. No. 5,628,557A, it is stated that “An assembly tube light including at least two tube lights and at least one connector for connecting each two tube lights either in line or at right angles, each tube light having a first conductor, a second conductor, a plurality of bulbs respectively connected between the first conductor and the second conductor, and two coupling units at two opposite ends, each coupling unit including two diagonal pairs of plug holes arranged in a square and respectively connected to the first conductor and the second conductor, each connector having two pairs of parallel contact pins arranged in a square corresponding to the plug holes of each coupling unit for inserting into two plug hole on a first tube light and two plug hole on a second tube light for permitting them to be fastened together and electrically connected in series, the two contact pins of the same pair being electrically connected together.” statements are included.

The patent application in question relates to mounting tube lights and more specifically, such a mounting tube light is described that allows tubes to be connected flush or at right angles.

Also in the literature, in the PCT application numbered WO2023274717A1, it is stated that “A lighting system for emitting light, the system comprising a first and a second lighting module as well as a plug for connecting the two lighting modules to each other, each lighting module comprises a housing, the housing having a first side and a second side, opposite to the first side, such that the second side of the first lighting module is connected to the first side of the second lighting module when the two lighting modules are connected via the plug, each housing comprises at least one Light Emitting Diode, LED, for emitting the light, a controller arranged for wirelessly communicating with the other one of the two lighting modules via a magnetic field antenna, the magnetic field antenna-wherein the first lighting module has the magnetic field antenna positioned in the housing close to, or adjacent, its second side and wherein the second lighting module has the magnetic field antenna positioned in the housing close to, or adjacent, its first side such that when the two lighting modules are connected using the plug, the magnetic field antennas of the first and second module are aligned.” statements are included.

In the aforementioned patent application, the lighting system consisting of two connectable lighting modules to emit light and its working method are explained.

For the reasons mentioned above, a new modular lighting fixture structure was needed.

### PURPOSE OF THE INVENTION

Based on this state of the art, the aim of the invention is to introduce a new modular lighting fixture structure that eliminates the existing disadvantages.

Another aim of the invention is to create a structure that enables various lighting needs such as table lamps, lampshades, bedside tables, and standing lighting fixtures needed in all residential and commercial living spaces to be met with a single product.

Another aim of the invention is to provide a structure that allows the user to make all product-related adaptations and settings that may be required while meeting the needs, without requiring any knowledge, expertise or tools.

Another aim of the invention is to provide a structure that allows the same product to be used for a different purpose when user needs change during the use of the product.

Another aim of the invention is to create a structure whose components can be easily produced and assembled with injection molding technology or 3D printing technology, since the assembly and cable connections of all components can be made from outside the bodies.

### EXPLANATION OF FIGURES

FIG. 1 Front view of the 6-modules multi-purpose modular lighting fixture structure that does not require multi-purpose assembly which is the subject of the invention.

FIG. 2 Left side view of the 6-modules, multi-purpose modular lighting fixture structure that does not require multi-purpose assembly, which is the subject of the invention.

FIG. 3 Top view of the 6-modules, multi-purpose modular lighting fixture structure that does not require multi-purpose assembly, which is the subject of the invention.

FIG. 4 Single-module perspective view of the multi-purpose modular lighting fixture structure that does not require assembly, which is the subject of the invention

FIG. 5 Another perspective view of the 6-module, multi-purpose modular lighting fixture structure that does not require assembly, which is the subject of the invention

FIG. 6 Perspective view of the 3-module, exploded version of the multi-purpose modular lighting fixture structure that does not require assembly, which is the subject of the invention

FIG. 7 Cross-sectional view showing the 3-module assembled state of the multi-purpose modular lighting fixture structure that does not require assembly, which is the subject of the invention.

FIG. 8 Exploded perspective view showing the sub-components of the base in the multi-purpose modular lighting fixture structure that does not require assembly, which is the subject of the invention.

FIG. 9 Cross-sectional view showing the assembled state of the base and its sub-components in the multi-purpose modular lighting fixture structure that does not require assembly, which is the subject of the invention.

FIG. 10 Perspective view of the exploded version showing the sub-components of the lighting module in the multi-purpose modular lighting fixture structure that does not require assembly, which is the subject of the invention.

FIG. 11 Cross-sectional view showing the assembled state of the lighting module, sub-components in the multi-purpose modular lighting fixture structure that does not require assembly, which is the subject of the invention.

FIG. 12 Perspective view of the end piece in the multi-purpose modular lighting fixture structure that does not require assembly, which is the subject of the invention.

FIG. 13 Cross-sectional view of the end piece in the multi-purpose modular lighting fixture structure that does not require assembly, which is the subject of the invention

FIG. 14 Perspective view of the exploded version showing the sub-components of the fastener in the multi-purpose modular lighting fixture structure that does not require assembly, which is the subject of the invention.

FIG. 15 Cross-sectional view showing the assembled state of the fastener in the multi-purpose modular lighting fixture structure that does not require assembly, which is the subject of the invention

### REFERENCE NUMBERS

A-Modular Lighting Fixture Structure
1. Base
   1.1 Base Body
   1.2 Control Unit
   1.3 Ring LED
   1.4 Base Cover
   1.5 Control Button
   1.6 Base Wedges
   1.7 Control Unit Fixing Screws
   1.8 Base Cover Fixing Screws
2. Lighting Module
   2.1 Lighting Module Body
   2.2 Female Magnetic Connector
   2.3 Female Magnetic Connector Fixing Slot
   2.4 Lampholder Fixing Slot
   2.5 Lampholder
   2.6 LED Lamp
   2.7 Lampholder Fixing Screws
3. End Piece
4. Fastener
   4.1 Fastener Body
   4.2 Male Magnetic Connector
   4.3 Connector Cover

### Detailed Description of the Invention

In this detailed explanation, the innovation that is the subject of the invention is explained only with examples that will not create any limiting effect for a better understanding of the subject.

The invention is a modular lighting fixture structure (A) containing more than one lighting module (2) that meets the lighting need with a single product through table

lamp, lampshade, bedside lighting fixture and standing lighting fixture, can be transformed into the fixture to be used by the user at that moment according to the purpose of use without requiring any assembly or fixing, and performs the lighting function characterized in that; comprises a base (1) provides control of power transfer by keeping the structure balanced on the ground where it is positioned and at the same time meeting the energy needs of the said lighting module (2), fastener (4) that provides both electrical and mechanical connection of multiple lighting modules (2) to each other, allows the lighting modules (2) to rotate 360° around themselves thanks to its cylindrical structure, and allows the lighting modules (2) to be directed upwards or downwards thanks to its fully symmetrical structure.

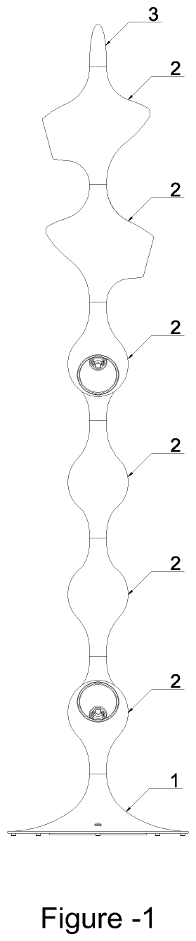

FIG. 1 shows front view of the 6-modules multi-purpose modular lighting fixture structure (A) that does not require multi-purpose assembly which is the subject of the invention.

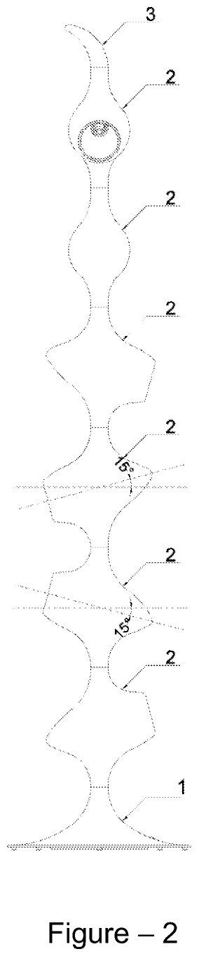

FIG. 2 shows left side view of the 6-modules, multi-purpose modular lighting fixture structure (A) that does not require multi-purpose assembly, which is the subject of the invention.

FIG. 3 shows top view of the 6-modules, multi-purpose modular lighting fixture structure (A) that does not require multi-purpose assembly, which is the subject of the invention.

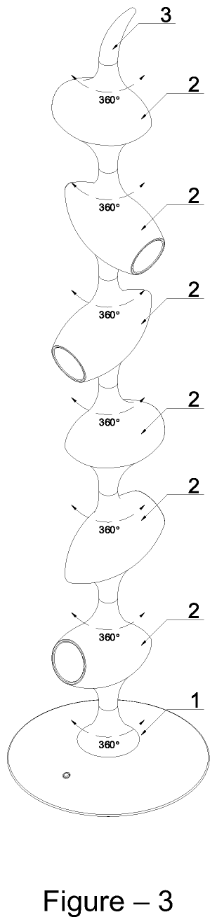

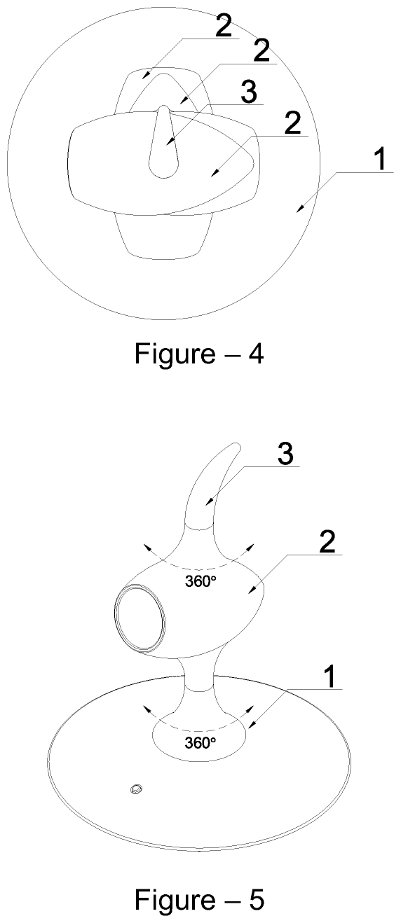

FIG. 4 shows single-module perspective view of the multi-purpose modular lighting fixture structure (A) that does not require assembly, which is the subject of the invention.

FIG. 5 shows another perspective view of the 6-module, multi-purpose modular lighting fixture structure (A) that does not require assembly, which is the subject of the invention.

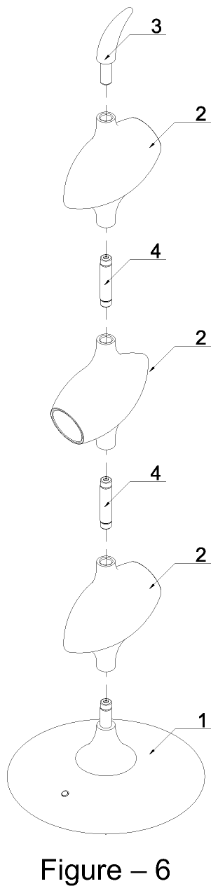

FIG. 6 shows perspective view of the 3-module, exploded version of the multi-purpose modular lighting fixture structure (A) that does not require assembly, which is the subject of the invention.

FIG. 7 shows cross-sectional view showing the 3-module assembled state of the multi-purpose modular lighting fixture structure (A) that does not require assembly, which is the subject of the invention.

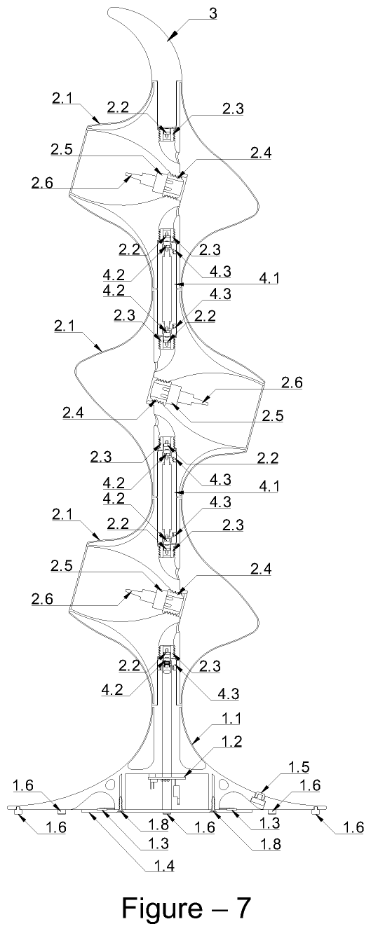

FIG. 8 shows exploded perspective view showing the sub-components of the base (1) in the multi-purpose modular lighting fixture structure (A) that does not require assembly, which is the subject of the invention.

FIG. 9 shows cross-sectional view showing the assembled state of the base (1) and its sub-components in the multi-purpose modular lighting fixture structure (A) that does not require assembly, which is the subject of the invention.

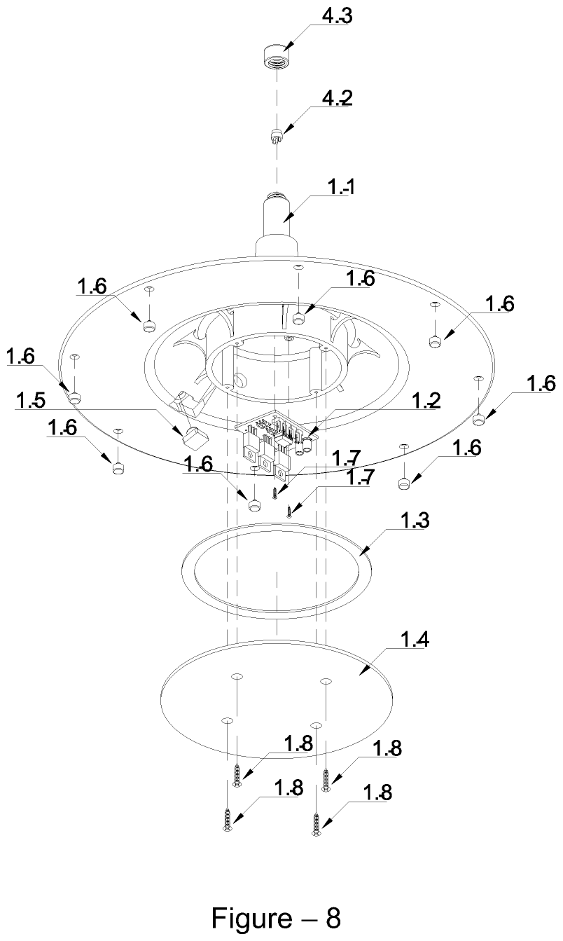

FIG. 10 shows perspective view of the exploded version showing the sub-components of the lighting module (2) in the multi-purpose modular lighting fixture structure (A) that does not require assembly, which is the subject of the invention.

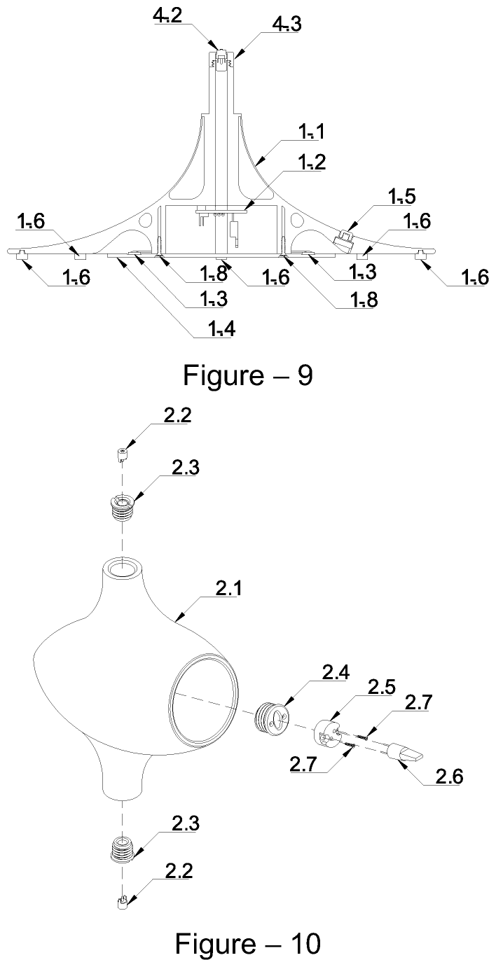

FIG. 11 shows cross-sectional view showing the assembled state of the lighting module (2), sub-components in the multi-purpose modular lighting fixture structure (A) that does not require assembly, which is the subject of the invention.

FIG. 12 shows perspective view of the end piece (3) in the multi-purpose modular lighting fixture structure (A) that does not require assembly, which is the subject of the invention.

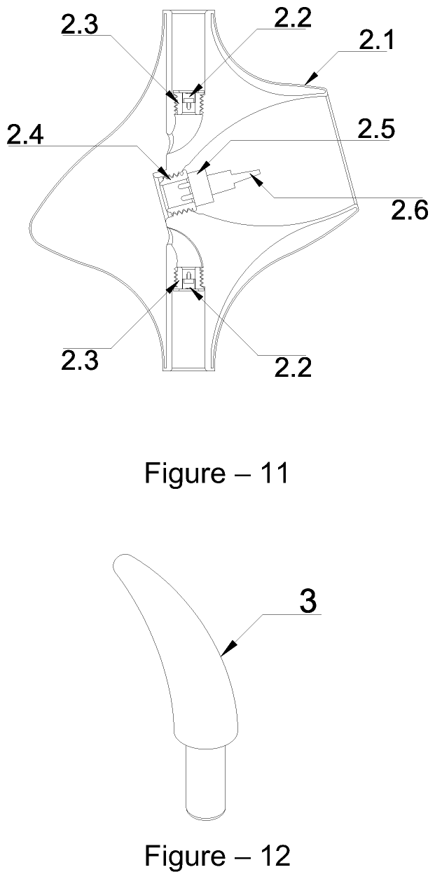

FIG. 13 shows cross-sectional view of the end piece (3) in the multi-purpose modular lighting fixture structure (A) that does not require assembly, which is the subject of the invention.

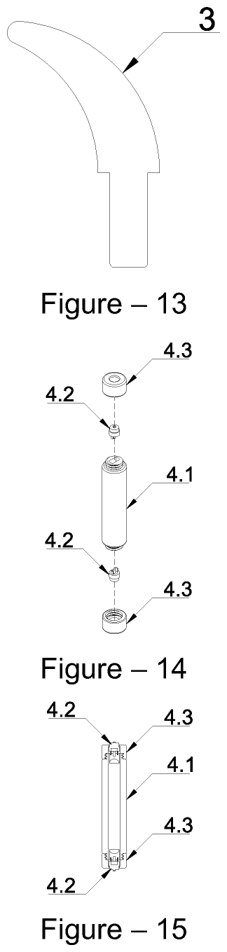

FIG. 14 shows perspective view of the exploded version showing the sub-components of the fastener (4) in the multi-purpose modular lighting fixture structure (A) that does not require assembly, which is the subject of the invention.

FIG. 15 shows cross-sectional view showing the assembled state of the fastener (4) in the multi-purpose modular lighting fixture structure (A) that does not require assembly, which is the subject of the invention.

The invention basically consists of four main components. These parts are one or more lighting modules (2) that perform the lighting function, the base (1) provides control of power transfer by keeping the structure balanced on the ground where it is positioned and at the same time meeting the energy needs of the said lighting module (2), the end piece (3) connected to the lighting module (2) at the top in order to end the said modular lighting structure (A) and fastener (4) that provides both electrical and mechanical connection of multiple lighting modules (2) to each other, allows the lighting modules (2) to rotate 360° around themselves thanks to its cylindrical structure, and allows the lighting modules (2) to be directed upwards or downwards thanks to its fully symmetrical structure. In the minimum configuration, needs for purposes such as table lamps and work lamps can be met by using one of these components: base (1), lighting module (2) and end piece (3).

The said base (1) consists main parts of; the base body (1.1) that forms the main body of the said base (1), the control unit (1.2) located inside the base (1), which allows the adjustment of on-off and light intensity, and to which electronic cards for remote control and automation technologies such as wifi, Bluetooth, internet of things (IOT) can be added, and which manages the energy fed by 12 Volt DC current, ring LED (1.3), positioned for illumination of the base (1) itself, base cover (1.4) positioned as the bottom cover of the said base (1), control button (1.5) that controls the said control unit (1.2), base wedges (1.6), which raise the said base (1) from the ground and tolerate small imbalances on the ground and provide passive ventilation and cooling of the control unit (1.2) and ring LED (1.3) located in the pedestal (1), control unit fixing screws (1.7), which enable the said control unit (1.2) to be fixed by placing it in the middle space in the base body (1.1), base cover fixing screws (1.8) that enable the base cover (1.4) to be fixed to the base body (1.1) after being placed in the channel on its upper surface.

The said lighting module (2) consists of the lighting module body (2.1), which forms the main body of the lighting module (2), female magnetic connector (2.2) that provides electrical conduction, female magnetic connector fixing slot (2.3), used to fix the said female magnetic connector (2.2) to the threaded part on the lighting module body (2.1), the lampholder (2.5) on the front of the lighting module (2) into which the LED lamp (2.6) is installed, and the lampholder fixing slot (2.4) enables the said lampholder (2.5) to be fixed by turning it to the threaded part located at the front of the lighting module body (2.1), after being mounted on itself with the lampholder fixing screws (2.7).

The said fastener (4) consists of the fastener body (4.1) that forms the main body, male magnetic connector (4.2), which fits into a slot with a threaded structure on the outside, located at the upper and lower ends of the said fastener body (4.1), and performs the task of transmitting energy, the connector cover (4.3) compresses the said male magnetic connector (4.2) onto the said fastener body (4.1) in a way that creates a gap that allows it to move up and down 1 mm.

According to the user's intended use and demand, the lighting module (2) located between the base (1) and the end piece (3) can be installed as many times as desired, one for the first two lighting modules (2), and one for each subsequent lighting module (2). It can be multiplied by using the fastener (4) that provides the connection between them. The user can position each of these lighting modules (2) to point up or down, independently of the others, and can rotate their direction horizontally as desired, independently of the others. In the minimum structure created with 1 base (1), 1 lighting module (2) and 1 end piece (3), the total height of the structure from the ground is 33.8 cm. Each lighting module (2) added to the structure is 18 cm high. The total height of the structure, which will be created with 10 lighting modules, is 195.8 cm. Embodiments created with 6 or more lighting modules (2) are suitable for uses such as general lighting and floor lamps.

There is a fastener (4) between the lighting modules (2), which enables them to be mechanically and electrically connected to each other and allows the lighting modules (2) to rotate 360°around themselves. In the modular lighting structure (A), the lighting modules (2) rotating infinitely horizontally does not cause any problems, and there is no restriction regarding this in the structure. The said fastener (4) allows the lighting modules (2) to be directed upwards or downwards, thanks to its fully symmetrical structure.

The base (1) located in the mentioned modular lighting fixture structure (A) keeps the structure balanced on the ground it is positioned on, is controlled by the user by pressing the control button (1.5) on it and allows on/off and adjustment of light intensity (dim). It contains the control unit (1.2), to which electronic cards for remote control and automation technologies such as wifi, bluetooth, internet of things (IOT) can be added, which is fed by 12 Volt DC current and receives the energy managed by the control unit (1.2). Thanks to the male magnetic connector (4.2), it is positioned as the component that transmits it to the first lighting module (2) installed on it.

The male magnetic connector (4.2), which is located at the top of the said base (1) and transmits the energy to the lighting modules (2), fits into the gap at the end of the base body (1.1), whose outer part has a threaded structure for screwing the connector cover (4.3). When the connector cover (4.3) and the end part of the base body (1.1) are fixed by turning them towards each other, the male magnetic connector (4.2) is fixed in a way that it can move up and down by 1 mm. In this way, full contact with the female magnetic connector (2.2) located in the lighting module (2) and through which electricity is transmitted is ensured.

The control button (1.5), which is located on the said base (1) and controls the control unit (1.2), is fixed by passing into the space left in the base body (1.1), the size of the control button (1.5). The said control unit (1.2) is placed in the middle space in the base body (1.1) and is fixed to the base body (1.1) with 2 control unit fixing screws (1.7).

The 4 sockets on the control unit (1.2) provide 12 Volt direct current supply, control button (1.5), ring LED (1.3) supply and male magnetic connector (4.2) connections with the connected cables.

The ring LED (1.3), located on the said base (1) and used to illuminate the base (1) itself, is fixed by fitting into the channel on the upper surface of the base cover (1.4). Then, the base cover (1.4) is fixed by screwing it to the base body (1.1) with four base cover fixing screws (1.8).

Eight base wedges (1.6) located under the base (1) are fixed by passing them into eight cylindrical spaces located under the base body (1.1). Thus, the base (1) is raised 4 mm from the ground. In this way, small imbalances on the ground are tolerated and the control unit (1.2) and ring LED (1.3) located in the base (1) are passively ventilated and cooled.

The lighting module (2) located in the modular lighting fixture configuration (A) can be used by adding the desired amount between the base (1) and the end piece (3) depending on the intended use. By using a fastener (4) between both lighting modules (2), the lighting modules (2) are fixed to each other and their electrical transmission is ensured.

The said lighting module (2) has a symmetrical structure at its upper and lower ends. There are cylindrical spaces at both ends where the fastener (4) or the end part of the base (1) will fit. At the end of these cylindrical spaces, there is a female magnetic connector (2.2) that provides electrical transmission and a female magnetic connector fixing slot (2.3) used to fix this female magnetic connector (2.2) to the threaded part on the lighting module body (2.1).

After being mounted on the front of the lighting module (2) with the lampholder (2.5) into which the LED lamp (2.6) is attached and the lampholder fixing screws (2.7), the said lampholder (2.5) is rotated and fixed to the threaded part located at the front of the lighting module body (2.1). There is a lampholder fixing slot (2.4). Thanks to the female magnetic connector (2.2) located at the bottom of the lighting module (2), it senses the energy it receives from the base (1) or the lighting module (2) located below it, with the help of cables, and from there, again with the help of cables, it transmits the energy it receives from the lighting module (2) located above it. It is transmitted to the female magnetic connector (2.2) located on the upper part in order to be transmitted to the lighting module (2).

In the modular lighting structure (A), a fastener (4) is used between the lighting modules (2) to connect the lighting modules (2) to each other and to ensure electrical transmission between them. The said fastener (4) has a cylindrical and symmetrical structure. It has no direction of use, it can be used bidirectionally, thus allowing the lighting modules (2) to be connected bidirectionally, oriented upwards or downwards.

Thanks to two male magnetic connectors (4.2) located at both ends and connected to each other with cables, it transmits the energy it receives from the lighting module (2) located below to the lighting module (2) located above. The male magnetic connector (4.2) is attached to the outer threaded section at both ends of the fastener body (4.1), the inside of which is threaded, so that it moves up and down 1 mm between the space at both ends of the fastener body (4.1) and the connector cover (4.3). It is fixed by turning the connector cover (4.3), which has a structure.

In the modular lighting structure (A), the end piece (3) is placed on top of the last lighting module (2), in order to close the cylindrical gap left for the fastener (4) located at the top of the lighting module body (2.1) and to end the modular lighting structure (A) is used. The said end piece (3) has a mono-block structure.

1. A modular lighting fixture structure containing more than one lighting module that meets lighting needs with a single product through table lamp, lampshade, bedside lighting fixture and standing lighting fixture, can be transformed into the fixture to be used by the user at that moment according to the purpose of use without requiring any assembly or fixing, and performs the lighting function, the modular lighting fixture structure comprising: a base providing control of power transfer by keeping the structure balanced on the ground where it is positioned and at the same time meeting the energy needs of the said lighting module a fastener that provides both electrical and mechanical connection of multiple lighting modules to each other, allows the lighting modules to rotate 360° around themselves thanks to its cylindrical structure, and allows the lighting modules to be directed upwards or downwards thanks to its fully symmetrical structure.

2. A modular lighting fixture structure according to claim 1, wherein said fastener comprises a fastener body that forms the main body, a male magnetic connector which fits into a slot with a threaded structure on the outside, located at upper and lower ends of the said fastener body and performs the task of transmitting energy, a connector cover compresses the said male magnetic connector onto the said fastener body in a way that creates a gap that allows it to move up and down 1 mm.

3. A modular lighting fixture structure according to claim 1, comprising an end piece connected to the lighting module at the top in order to terminate the mentioned modular lighting structure

4. A modular lighting fixture structure according to claim 1, comprising a control unit located inside the base, which allows the adjustment of on-off and light intensity, and to which electronic cards for remote control and automation technologies such as wifi, Bluetooth, internet of things (IOT) can be added, and which manages the energy fed by 12 Volt DC current.

5. A modular lighting fixture structure according to claim 1, wherein the base contains a ring LED positioned to illuminate itself.

6. A modular lighting fixture structure according to claim 1, wherein the said base contains a base cover positioned as its bottom cover.

7. A modular lighting fixture structure according to claim 1, comprising a control button that controls the said control unit

8. A modular lighting fixture structure according to claim 1, comprising base wedges that raise the said base from the ground, both tolerating small imbalances on the ground and ensuring passive cooling of a control unit and a ring LED located in the base by ventilation.

9. A modular lighting fixture structure according to claim 4, comprising control unit fixing screws that enable the said control unit to be fixed by placing it in the middle space in the base body

10. A modular lighting fixture structure according to claim 6, comprising base cover fixing screws that enable the base cover to be fixed to the base body after being placed in the channel on its upper surface.

11. A modular lighting fixture structure according to claim 2, comprising a female magnetic connector which provides electrical conduction by contacting itself after the up and down movement of the said male magnetic connector and which transfers the energy it receives from the said base or the lighting module located below it, to a lampholder located on the lighting module with the help of cables, and then to the lighting module located above it, with the help of cable.

12. A modular lighting fixture structure according to claim 11, comprising a female magnetic connector fixing slot used to fix the said female magnetic connector to the threaded part located on the lighting module body which is formed as the main body of the lighting module.

13. A modular lighting fixture structure according to claim 11, comprising comprises a lampholder fixing slot which enables the said lampholder to be fixed by turning it to the threaded part located at the front of the lighting module body after being mounted on itself with the lampholder fixing screws

14. A modular lighting fixture structure according to claim 1, wherein said lighting module contains cylindrical and symmetrical spaces at its upper and lower ends into which the end part of the fastener or the base will fit.

15. A modular lighting fixture structure according to claim 3, wherein said end piece has a monoblock structure.
